(19) United States
(12) Patent Application Publication
(10) Pub. No.: US 2026/0270412 A1
(43) Pub. Date: Sep. 10, 2026

(54) COMBINED PREDICTION MODE

(71) Applicant: MEDIATEK INC., Hsinchu City (TW)

(72) Inventors: Man-Shu CHIANG, Hsinchu City (TW); Chih-Wei HSU, Hsinchu City (TW)

(21) Appl. No.: 19/473,099

(22) PCT Filed: Jul. 19, 2024
(86) PCT No.: PCT/CN2024/106320

§ 371 Date: Oct. 6, 2025

Related U.S. Application Data
(60) Provisional application No. 63/514,826, filed on Jul. 21, 2023.

(51) Int. Cl. H04N 19/11; H04N 19/105; H04N 19/176; H04N 19/593

(52) U.S. Cl. CPC H04N 19/11; H04N 19/105; H04N 19/176; H04N 19/593

(57) ABSTRACT

A method for using combined prediction to encode or decode pixel blocks is provided. A video coder receives data to be encoded or decoded as a current block of pixels of a current picture of a video. The video coder selects a first prediction mode information (PMI) candidate from one or more PMI candidates comprising information associated with intra prediction mode or block vector. The first PMI candidate may be selected based on template costs of the one or more PMI candidates which may be in a list. The video coder generates a first predictor for the current block based on the selected first PMI candidate. The video coder generates a second predictor for the current block. The video coder generates a final predictor based on the first predictor and the second predictor. The video coder encodes or decodes the current block based on the final predictor.

### CROSS REFERENCE TO RELATED PATENT APPLICATION(S)

The present disclosure is part of a non-provisional application that claims the priority benefit of U.S. Provisional Patent Application No. 63/514,826, filed on 21 Jul. 2023. Content of above-listed application is herein incorporated by reference.

### TECHNICAL FIELD

The present disclosure relates generally to video coding. In particular, the present disclosure relates to methods of coding pixel blocks by combining multiple different predictors.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors (MVs) and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical triple-tree partitioning, horizontal triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and/or two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and/or associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signaled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighboring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signaled explicitly per each CU.

In order to improve the coding performance and/or to reduce complexity for a system using predictors, methods and apparatus of coding pixel blocks by combining multiple different predictors are disclosed.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide methods for using combined prediction to encode or decode pixel blocks. A video coder receives data to be encoded or decoded as a current block of pixels of a current picture of a video. The video coder selects at least one first prediction mode information (PMI) candidate from one or more PMI candidates comprising information associated with intra prediction mode or block vector. The at least one first PMI candidate may be selected based on template costs of the one or more PMI candidates which may be in a list. The video coder generates at least one first predictor for the current block based on the selected at least one first PMI candidate. The video coder generates a second predictor for the current block. The video coder generates a final predictor based on the at least one first predictor and the second predictor. The video coder encodes or decodes the current block based on the final predictor.

The one or more PMI candidates may include spatial adjacent, spatial non-adjacent, history, temporal, and/or default candidates. In some embodiments, the one or more PMI candidates are derived from a merge candidate list.

In some embodiments, each PMI specifies a mode-type and/or a mode-setting. For a first example, the mode-type may indicate that an intra prediction predictor is to be generated for the current block, and the mode-setting may indicate information associated with an intra prediction mode comprising angular direction or DC mode or planar mode for the intra prediction predictor. For a second example, the mode-type may indicate intraTMP mode, and the mode-setting may specify information associated with a block vector that is used for identifying a reference block in the current picture as a predictor for the current block. For a third example, the mode-type may indicate intra block copy (IBC) mode and the mode-setting may specify information associated with a block vector that is used for identifying a reference block in the current picture as a predictor for the current block.

In some embodiments, the at least one first PMI candidate is selected from the one or more PMI candidates, which may be in a list, based on template costs of more than one PMI candidates. The encoder or decoder may select more than one first PMI candidates from the more than one PMI candidates. The more than one first PMI candidates may have different mode-types. The more than one first PMI candidates may be selected from more than one PMI candidates, which may be in a list, based on template costs associated with the more than one PMI candidates.

The at least one first and/or second PMI candidates are used to generate at least a first prediction hypothesis and a second prediction hypothesis, which are blended to generate the final predictor. Weighting for the first prediction hypothesis and/or second prediction hypothesis may be determined based on template costs associated with the at least one first and/or second PMI candidates.

In some embodiments, an enabling flag may be signaled to indicate that a combined prediction mode such as CIIP is used for the current block, such that at least one first predictor and second predictor are combined to generate the final predictor in a manner similar to CIIP, e.g., according to weighting value that is determined based on modes of coded neighbors above and left of the current block.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 shows the intra-prediction modes in different directions.

FIGS. 2A-B conceptually illustrate top and left reference samples with extended lengths for supporting wide-angular direction modes for non-square blocks of different aspect ratios.

FIG. 3 illustrates using template-based intra mode derivation (TIMD) to implicitly derive an intra prediction mode for a current block.

FIG. 4 illustrates using decoder-side intra mode derivation (DIMD) to implicitly derive an intra prediction mode for a current block.

FIG. 5 conceptually illustrates intra block copy (IBC).

FIG. 6 illustrates template matching prediction process.

FIG. 7 illustrates the positions of spatial merge candidates.

FIG. 8 shows spatial neighboring blocks used to derive the spatial merge candidates.

FIG. 9 illustrates motion vector scaling for temporal merge candidate.

FIG. 10 shows candidate positions for temporal merge candidate.

FIG. 11 shows the positions of the top and left neighboring blocks for determining the weighting of the inter and intra prediction signals for a current block.

FIG. 12 illustrates an example video encoder.

FIG. 13 illustrates portions of the video encoder that implement combined prediction.

FIG. 14 conceptually illustrates a process for encoding a pixel block using combined prediction.

FIG. 15 illustrates an example video decoder.

FIG. 16 illustrates portions of the video decoder that implement combined prediction.

FIG. 17 conceptually illustrates a process for decoding a pixel block using combined prediction.

FIG. 18 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Intra Prediction Modes

a. Directional Intra Prediction Modes

Intra-prediction method exploits one reference tier which may be adjacent to the current prediction unit (PU) and one of the intra-prediction modes to generate the predictors for the current PU. The Intra-prediction direction can be chosen among a mode set containing multiple prediction directions. For each PU coded by Intra-prediction, one index will be used and encoded to select one of the intra-prediction modes. The corresponding prediction will be generated and then the residuals can be derived and transformed.

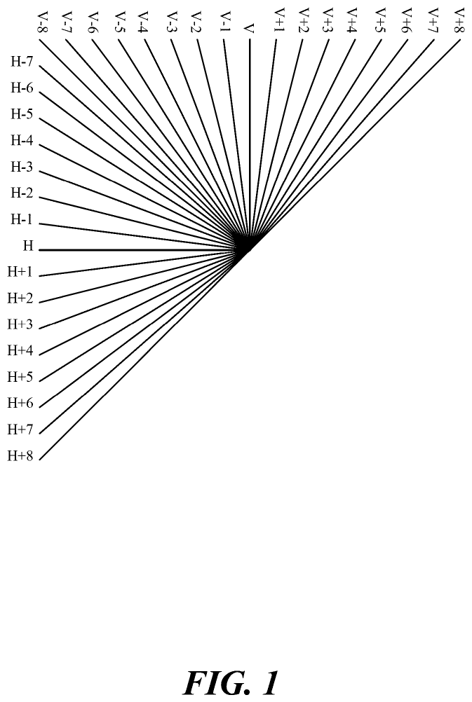

FIG. 1 shows the intra-prediction modes in different directions. These intra-prediction modes are referred to as directional modes and do not include DC mode or Planar mode. As illustrated, there are 33 directional modes (V: vertical direction; H: horizontal direction), so H, H+1~H+8, H−1~H−7, V, V+1~V+8, V−1~V−8 are used. Generally directional modes can be represented as either as H+k or V+k modes, where k=±1, ±2, . . . , ±8. Each of such intra-prediction mode can also be referred to as an intra-prediction angle. To capture arbitrary edge directions presented in natural video, the number of directional intra modes may be extended from 33, as used in HEVC, to 65 direction modes 30 so that the range of k is from ±1 to ±16. These denser directional intra prediction modes apply for all block sizes and for both luma and chroma intra predictions. By including DC and Planar modes, the number of intra-prediction mode is 35 (or 67).

The intra-prediction mode determined for the luma component may be directly used for the chroma component. This is referred to as chroma DM (direct mode).

Out of the 35 (or 67) intra-prediction modes, some modes (e.g., 3 or 5) are identified as a set of most probable modes (MPM) for intra-prediction in current prediction block. The encoder may reduce bit rate by signaling an index to select one of the MPMs instead of an index to select one of the 35 (or 67) intra-prediction modes. For example, the intra-prediction mode used in the left prediction block and the intra-prediction mode used in the above prediction block are used as MPMs.

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signaled using the original mode indices, which are remapped to indices of wide angular modes after parsing.

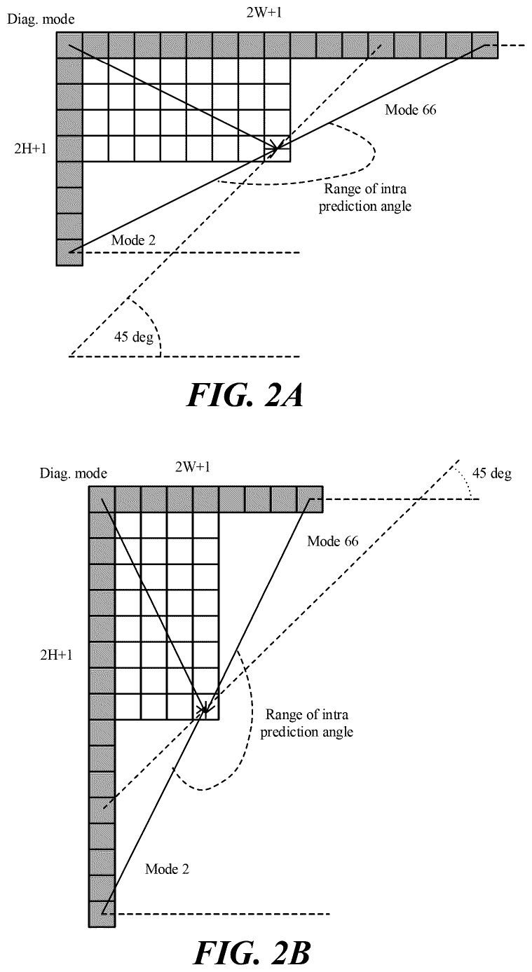

For some embodiments, the total number of intra prediction modes is unchanged, i.e., 67, and the intra mode coding method is unchanged. To support these prediction directions, a top reference samples with length 2 W+1 and a left reference samples with length 2H+1 are defined. FIGS. 2A-B conceptually illustrate top and left reference samples with extended lengths for supporting wide-angular direction mode for non-square blocks of different aspect ratios.

The number of replaced modes in wide-angular direction mode depends on the aspect ratio of a block. The replaced intra prediction modes for different blocks of different aspect ratios are shown in Table 1 below.

TABLE 1
Intra prediction modes replaced by wide-angular modes

| Aspect ratio | Replaced intra prediction modes |
|---|---|
| W/H == 16 | Modes 2, 3, 4, 5, 6, 7, 8, 9, 10, 11, 12, 13, 14, 15 |
| W/H == 8 | Modes 2, 3, 4, 5, 6, 7, 8, 9, 10, 11, 12, 13 |
| | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == ½ | Modes 59, 60, 61, 62, 63, 64, 65, 66 |
| W/H == ¼ | Modes 57, 58, 59, 60, 61, 62, 63, 64, 65, 66 |
| W/H == ⅛ | Modes 55, 56, 57, 58, 59, 60, 61, 62, 63, 64, 65, 66 |
| W/H == 1/16 | Modes 53, 54, 55, 56, 57, 58, 59, 60, 61, 62, 63, 64, 65, 66 |

b. Template-Based Intra Mode Derivation (TIMD)

For mode selection, template matching method can be applied by computing the cost between reconstructed samples and predicting samples on the template. One of the examples is template-based intra mode derivation (TIMD). TIMD is a coding method in which the intra prediction mode of a CU is implicitly derived by using a neighboring template at both encoder and decoder, instead of the encoder signaling the exact intra prediction mode to the decoder.

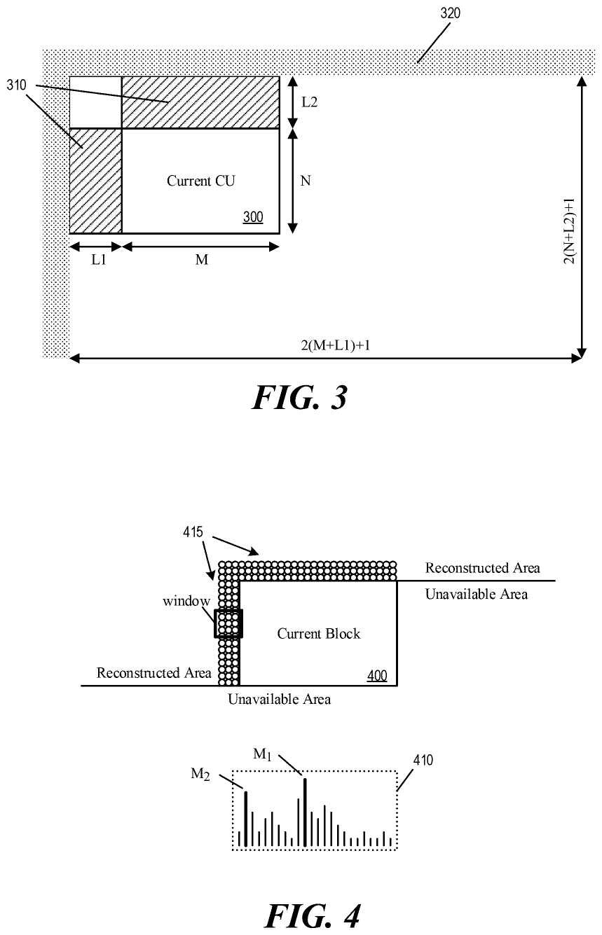

FIG. 3 illustrates using template-based intra mode derivation (TIMD) to implicitly derive an intra prediction mode for a current block 300. As illustrated, the neighboring pixels of the current block 300 is used as template 310. For each candidate intra prediction mode, prediction samples of the template 310 are generated using the reference samples, which are in a L-shape reference region 320 above and left of the template 310. A TM cost for a candidate intra prediction mode is calculated based on a difference (e.g., SATD) between reconstructed samples of the template and the prediction samples of the template generated by the candidate intra prediction mode. The candidate intra prediction mode with the minimum cost is selected (as the TIMD mode similar to the implicit mode derivation in the DIMD mode) and used for intra prediction of the CU. The candidate intra prediction modes may include 67 intra prediction modes (as in VVC) or extended to 131 intra prediction modes. MPMs may be used to indicate the directional information of a CU. Thus, to reduce the intra mode search space and utilize the characteristics of a CU, the intra prediction mode is implicitly derived from the MPM list.

In some embodiments, for each intra prediction mode in the MPM list, the SATD between the prediction and reconstructed samples of the template is calculated as the TM cost of the intra prediction mode. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes.

The costs of two selected intra prediction modes (mode1 and mode2) are compared with a threshold, for example, the cost factor of 2 is applied as follows:

$$costMode 2 < 2 * costMode 1$$

If this condition is true, the prediction fusion is applied, otherwise only mode1 is used. Weights of the modes are computed from their SATD costs as follows:

$$weight 1 = costMode 2 / ( costMode 1 + costMode 2 ) \\ weight 1 = 1 - weight 1$$

c. Decoder Side Intra Mode Derivation (DIMD)

Decoder-Side Intra Mode Derivation (DIMD) is a technique in which one or more, for example, two, intra prediction modes such as angles or directions are derived from the reconstructed neighbor samples (template) of a block, and those two predictors are combined with non-angular predictor such as the planar mode predictor with the weights derived from the gradients. The DIMD mode is used as an alternative prediction mode and/or is always checked in high-complexity RDO mode. To implicitly derive the intra prediction modes of a block, a texture gradient analysis is performed at both encoder and decoder sides. This process starts with an empty Histogram of Gradient (HoG) having 65 entries, corresponding to the 65 angular/directional intra prediction modes. Amplitudes of these entries are determined during the texture gradient analysis.

A video coder performing DIMD performs the following steps: in a first step, the video coder picks a template of T=3 columns and lines from respectively left and above current block. This area is used as the reference for the gradient based intra prediction modes derivation. In a second step, the horizontal and vertical Sobel filters are applied on all 3×3 window positions, centered on the pixels of the middle line of the template. On each window position, Sobel filters calculate the intensity of pure horizontal and vertical directions as Gₓ and G_{y}, respectively. Then, the texture angle of the window is calculated as:

$$angle = arctan ( {G}_{x} / {G}_{y} ) ,$$

which can be converted into one of the 65 angular intra prediction modes. Once the intra prediction modes index of current window is derived as idx, the amplitude of its entry in the HoG[idx] is updated by addition of

$$ampl = \vert {G}_{x} \vert + \vert {G}_{y} \vert$$

FIG. 4 illustrates using decoder-side intra mode derivation (DIMD) to implicitly derive an intra prediction mode for a current block. The figure shows an example Histogram of Gradient (HoG) 410 that is calculated after applying the above operations on all pixel positions in a template 415 that includes neighboring lines of pixel samples around a current block 400. Once the HoG is computed, the indices of the two tallest histogram bars (M₁ and M₂) are selected as the two implicitly derived intra prediction modes (IPMs) for the block. The prediction of the two IPMs are further combined with the planar mode prediction as the prediction of DIMD mode. The prediction fusion is applied as a weighted average of the above three predictors (M₁ prediction, M₂ prediction, and planar mode prediction). To this aim, the weight of planar may be set to 21/64 (~⅓). The remaining weight of 43/64 (~⅔) is then shared between the two HoG IPMs, proportionally to the amplitude of their HoG bars. The prediction fusion or combined prediction for DIMD can be:

$${Pred}_{DMD} = ( 43 * ( w 1 * {pred}_{M 1} + w2 * {pred}_{M 2} ) + 21 * {pred}_{planar} ) >> 6 \\ w 1 = {amp}_{M 1} / ( {amp}_{M 1} + {amp}_{M 2} ) \\ w 2 = {amp}_{M 2} / ( {amp}_{M 1} + {amp}_{M 2} )$$

In addition, derived intra prediction modes, for example, the two implicitly derived intra prediction modes, are added into the most probable modes (MPM) list, so the DIMD process is performed before the MPM list is constructed. The primary derived intra prediction mode of a DIMD block is stored with a block and is used for MPM list construction of the neighboring blocks.

As mentioned, when DIMD is applied, two intra prediction modes are derived from the reconstructed neighbor samples, and those two predictors are combined with the planar mode predictor with the weights derived from the gradients. The division operations in weight derivation are performed utilizing the same lookup table (LUT) based integerization scheme used by the CCLM. For example, the division operation in the orientation calculation

$$Orient = {G}_{y} / {G}_{x}$$

is computed by the following LUT-based scheme:

$$x = Floor ( Log 2 ( G x ) ) \\ normDiff = ( ( Gx << 4 ) >> x ) \& 15 \\ x += ( 3 + ( normDiff != 0 ) ? 1 : 0 )$$

$$Orient = ( Gy * ( DivSigTable [ normDiff ] \vert 8 ) + ( 1 << ( x - 1 ) ) ) >> x \\ where \\ DivSigTable [ 16 ] = \{ 0 , 7 , 6 , 5 , 5 , 4 , 4 , 3 , 3 , 2 , 2 , 1 , 1 , 1 , 1 , 0 \} .$$

### II. Current Picture Referencing

a. Intra Block Copy (IBC)

Motion Compensation is a video coding process that explores the pixel correlation between adjacent pictures. It is generally assumed that in a video sequence the patterns corresponding to objects or background in a frame are displaced to form corresponding objects on the subsequent frame or correlated with other patterns within the current frame. With the estimation of such a displacement (e.g., using block matching techniques), the pattern could be mostly reproduced without needing to re-code the pattern. Block matching and copy allows selecting the reference block from within the same picture, but it is observed to be not as efficient when applied to camera captured videos. Part of the reasons is that textual pattern in a spatial neighboring area may be similar to the current coding block but usually with some gradual changes over space. It is therefore less likely for a block to find a good match within the same picture of a camera captured video, thereby limiting the improvement in coding performance.

However, the spatial correlation among pixels within the same picture is different for screen content. For a typical video with text and graphics, there are usually repetitive patterns within the same picture. Hence, intra (picture) block compensation has been observed to be very effective. Intra block copy (IBC) mode or current picture referencing (CPR) may therefore be used for screen content coding.

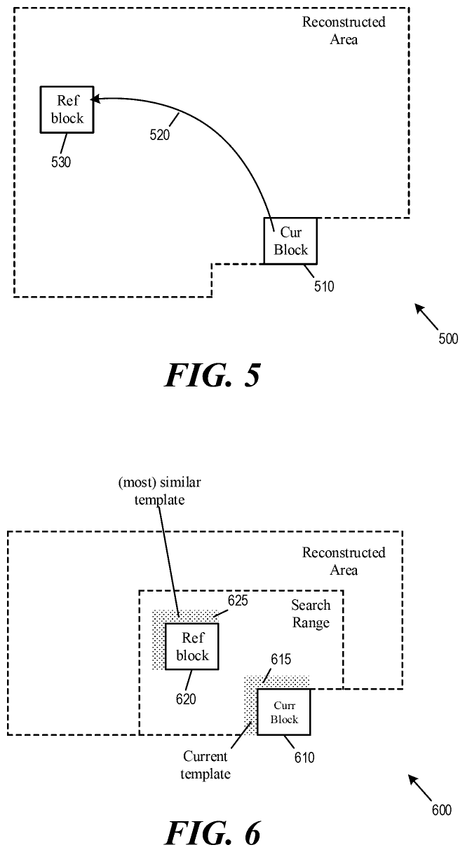

FIG. 5 conceptually illustrates intra block copy (IBC). As illustrated, a prediction unit (PU) as a current block 510 is predicted from a previously reconstructed block 530 within the same picture 500. A displacement vector 520 (called block vector or BV) is used to signal the relative displacement from the position of the current block to that of the reference block, which provides the reference samples used for generating a predictor of the current block. The prediction errors are then coded using transformation, quantization and entropy coding. The reference samples may correspond to the reconstructed samples of the current decoded picture prior to in-loop filter operations, both deblocking and sample adaptive offset (SAO) filters.

b. Template Matching Prediction (TMP)

Template matching prediction (TMP or called as intraTMP) is a special intra prediction mode that copies the best prediction block from the reconstructed part of the current frame, whose L-shaped template matches the current template. FIG. 6 illustrates template matching prediction process. As illustrated, for a predefined search range, the encoder searches for a most similar template to the current template 615 of the current block 610 in the reconstructed part of the current frame 600. A most similar template 625 is identified by the search, and its corresponding block 620 is used as a prediction block (as a reference block) for the current block 610. The encoder then signals the usage of this mode, and the inverse operation is made at the decoder side.

### III. Inter Prediction

a. Merge Candidate List

A number of inter prediction coding tools listed as followed:
Extended merge prediction
Merge mode with MVD (MMVD)
Symmetric MVD (SMVD) signalling
Affine motion compensated prediction
Subblock-based temporal motion vector prediction (SbTMVP)
Adaptive motion vector resolution (AMVR)
Motion field storage: 1/16^{th} luma sample MV storage and 8×8 motion field compression
Bi-prediction with CU-level weight (BCW)
Bi-directional optical flow (BDOF)
Decoder side motion vector refinement (DMVR)
Geometric partitioning mode (GPM)
Combined inter and intra prediction (CIIP)

For (regular) merge mode, the merge candidate list may be constructed by including the following five types of candidates in order:
Spatial MVP from spatial neighbour CUs (Spatial Merge Candidates)
Temporal MVP from collocated CUs (Temporal Merge Candidates)
History-based MVP from a FIFO table (HMVP Merge Candidate)
Pairwise average MVP (Pairwise Average Candidate)
Zero MVs.

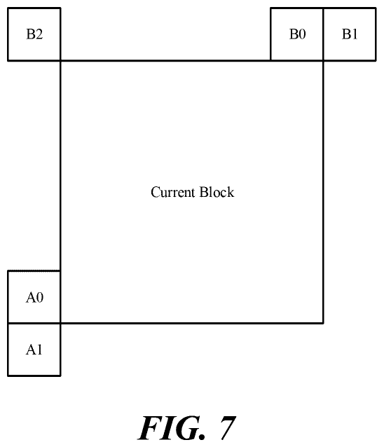

FIG. 7 illustrates the positions of spatial merge candidates. A maximum of four merge candidates are selected among candidates located in the positions depicted in the figure. The order of derivation is B₀, A₀, B₁, A₁ and B₂. Position B₂ is considered only when one or more than one CUs of position B₀, A₀, B₁, A₁ are not available (e.g. because it belongs to another slice or tile) or is intra coded. After candidate at position A₁ is added, the addition of the remaining candidates is subject to a redundancy check which ensures that candidates with same motion information are excluded from the list so that coding efficiency is improved.

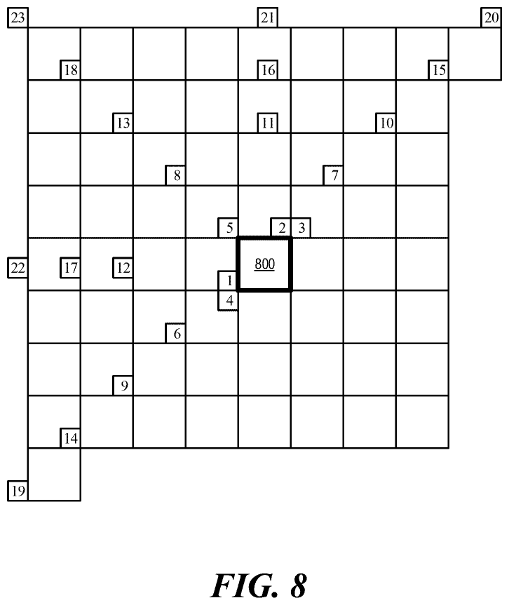

In addition to the above-mentioned spatial merge candidates, the non-adjacent spatial merge candidates are inserted after the TMVP (temporal MVP such as temporal merge candidate) in the regular merge candidate list. FIG. 8 shows spatial neighboring blocks used to derive the spatial merge candidates. The distances between non-adjacent spatial candidates and current coding block are based on the width and height of current coding block. The line buffer restriction is not applied.

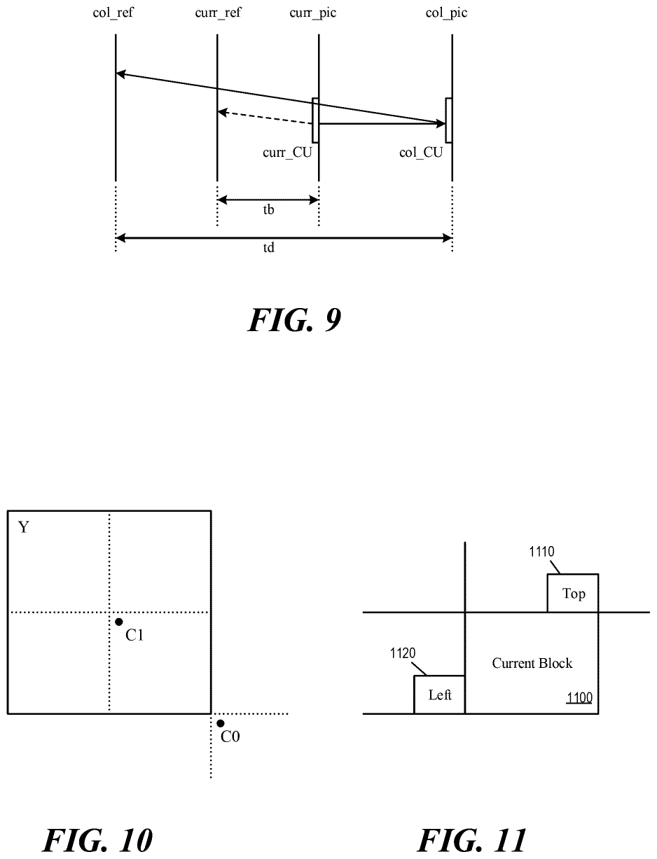

For temporal merge candidate, only one candidate is added to the list. Particularly, in the derivation of this temporal merge candidate, a scaled motion vector is derived based on co-located CU belonging to the collocated reference picture. The reference picture list and the reference index to be used for derivation of the co-located CU is explicitly signaled in the slice header. FIG. 9 illustrates motion vector scaling for temporal merge candidate. The scaled motion vector is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

FIG. 10 shows candidate positions for temporal merge candidate. As illustrated, the position for the temporal merge candidate is selected between candidates C₀ and C₁. If CU at position C₀ is not available, is intra coded, or is outside of the current row of CTUs, position C₁ is used. Otherwise, position C₀ is used in the derivation of the temporal merge candidate.

The history-based MVP (HMVP) merge candidates are added to merge list after the spatial MVP such as spatial merge candidates and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

Pairwise average candidates are generated by averaging predefined pairs of candidates in the existing merge candidate list, using the first two merge candidates. The first merge candidate is defined as p0Cand and the second merge candidate can be defined as p1Cand, respectively. The averaged motion vectors are calculated according to the availability of the motion vector of p0Cand and p1Cand separately for each reference list. If both motion vectors are available in one list, these two motion vectors are averaged even when they point to different reference pictures, and its reference picture is set to the one of p0Cand; if only one motion vector is available, use the one directly; if no motion vector is available, keep this list invalid. Also, if the half-pel interpolation filter indices of p0Cand and p1Cand are different, it is set to 0.

When the merge list is not full after pair-wise average merge candidates are added, the zero MVPs are inserted in the end until the maximum merge candidate number is encountered.

### IV. Combined Prediction

a. Combined Inter and Intra Prediction (CIIP)

When a CU is coded in merge mode, if the CU contains at least 64 luma samples (that is, CU width times CU height is equal to or larger than 64), and if both CU width and CU height are less than 128 luma samples, an additional flag may be signaled to indicate if combined inter/intra prediction (CIIP) mode is applied to the current CU.

The CIIP prediction combines an inter prediction signal with an intra prediction signal. The inter prediction signal in the CIIP mode Pᵢₙₜₑᵣ is derived using the same inter prediction process applied to regular merge mode; and the intra prediction signal Pᵢₙₜᵣₐ is derived following the regular intra prediction process with the planar mode. Then, the intra and inter prediction signals are combined using weighted averaging according to:

$${P}_{CIIP} = ( ( 4 - wt ) * {P}_{inter} + wt * {P}_{intra} + 2 ) >> 2$$

where the weight value wt is calculated depending on the coding modes of the top and left neighbouring blocks. FIG. 11 shows the positions of the top and left neighboring blocks 1110 and 1120 for determining the weighting of the inter and intra prediction signals for a current block 1100. The weighting values wt is calculated according to the following:
If the top neighbor 1110 is available and intra coded, then set isIntraTop to 1, otherwise set isIntra Top to 0;
If the left neighbor 1120 is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.
   b. Combined Prediction Based on Candidates

Some embodiments of the disclosure provide methods of coding pixel blocks using combined prediction. In some embodiments, the combined prediction is formed by combining a “mode-type” prediction (e.g., intra prediction) and an inter prediction using blending weighting. The “mode-type” prediction may be generated by the one or more prediction mode information suggested according to TIMD process, which selects a candidate prediction mode information based on template costs of different candidates. The combined prediction may be generated according to CIIP mode, which combines multiple prediction hypotheses generated by different prediction mode information.

In some embodiment, one or more candidate prediction mode information (PMI), which may be in a PMI candidate list, may be generated for the current block according to the prediction mode information of the previous coded blocks and/or default prediction mode information. In some embodiments, the PMI candidate list is aligned with the MPM list for regular intra mode.

The prediction mode information (PMI) may include mode-type, mode-setting (e.g., exact prediction mode such as information associated with intra prediction mode or block vector or other details of the mode-type), and/or any subset of above. For a first example, a PMI may specify mode-type=intra and/or mode-setting indicating information associated with an intra prediction mode (e.g., DC, planar, or any directional mode). For a second example, a PMI may specify mode-type=intraTMP and/or the mode-setting indicating information associated with the corresponding block vectors (that are obtained by searching in a pre-defined region using template matching). For a third example, a PMI may specify mode-type=IBC and/or the mode-setting indicating information associated with the corresponding block vectors. Block vectors can be used for identifying a reference block in the current picture as a predictor for the current block.

In some embodiments, when (i) a previous coded (i.e., encoded or decoded) block is available and (ii) the previous coded block's mode-type and/or the mode-setting and/or any pre-defined PMI is/are supported by the mode using the combined prediction mode, the prediction mode information of the previous coded block is considered valid and can be treated as a candidate and/or be inserted into the PMI candidates list. (For example, a PMI having a mode-setting specifying a block vector is valid for combined prediction which allows prediction from IBC mode or intraTMP mode.)

In some embodiments, all or any subset of the example PMIs discussed above (mode-type=intra or intraTMP or IBC) may be supported by the mode using the proposed combined prediction. In some embodiments, “all prediction mode information” refers to all stored prediction mode information (e.g., the mode-type and/or mode-setting), while “the subset of prediction mode information” may be only mode-type, or only mode-setting, or any pre-defined subset of “all prediction mode information”.

In some embodiments, the one or more PMI candidates, which may be in the PMI candidate list, may be any subset of the MPM candidate list for regular intra mode. Specifically, the previous coded blocks checked for construction of MPM list of regular intra mode will be checked for the one or more PMI candidates, for example, construction of the PMI candidate list. In some embodiments, the one or more PMI candidates, which may be in the PMI candidate list built for the current block, refer to merge candidates, which may be in a merge candidate list, that contain candidates with prediction mode information. In some embodiments, similar to the merge candidates, which may be in the merge candidate list, for regular inter merge mode, the merge candidates, which may be in a list (used as a PMI candidate list), include the candidates of spatial adjacent candidates, non-adjacent candidates, history candidates, temporal candidates, and default candidates, or any subset of above-mentioned candidates.

In some embodiments, the spatial adjacent candidates are from the adjacent neighboring blocks of the current block, where the adjacent neighboring blocks may be the same as the 5 spatial neighboring blocks for regular inter merge mode or any subset of the adjacent neighboring blocks of the current block. The non-adjacent candidates may be from a search range around (but not adjacent to) the current block. The search range may be the same as the search range of non-adjacent candidates for regular inter merge mode or different search range of the current block.

The history candidates are selected from a history-based buffer array. In the history-based buffer array, the prediction mode information of each valid previous coded block is stored where the valid previous coded block refers to any block containing supported prediction mode information (e.g., the supported mode-type including intraTMP and/or IBC, and/or the supported mode-setting including block vectors). Like what history candidates in the merge list of regular inter merge mode, the first stored information in the history buffer may be removed for including the information from the latest valid coded block if the buffer array is full. The buffer array is cleaned up (becomes empty) in the beginning or the end of a pre-defined unit. The pre-defined unit can be a CTU, CTU row, slice, tile, picture, or any pre-defined region. In some embodiments, the merge candidates, which may be in the list (as the PMI candidate list), refer to being from the history buffer array only. Specifically, only history candidates are included in the PMI candidates, which may be in the list, and/or those candidates from a far non-adjacent region are not included.

The temporal candidates are obtained from the prediction mode information stored for one or more pre-defined previous coded picture if the stored information is valid. In some embodiments, the temporal candidates are only available for inter slices which have the pre-defined previous coded picture such as the collocated picture for regular inter merge mode.

The default candidates are the candidates containing default (valid) prediction mode information, and/or the candidates derived according to the candidates already checked and/or put in the merge candidate list (as the PMI candidate list).

In some embodiments, the merge candidate list (as the PMI candidate list) is aligned with or is any subset of the merge candidate list for regular inter merge mode. In some embodiments, full or partial pruning is used to avoid duplicated prediction mode information in the merge candidate list. Before adding a candidate to the list, all or a subset of the prediction mode information of the to-be-added candidate is compared with the corresponding prediction mode information of all or any subset of the candidates already in the list.

In some embodiments, the video coder may implicitly select one or more (e.g., K) candidates from the one or more PMI candidates which may be in the PMI candidate list. The one or more selected candidates are used to generate one or more mode-type prediction for the current block. For example, if intra, intraTMP, and IBC (examples 1, 2, and 3) are all supported (allowed to be as PMI candidates which may be in the PMI candidate list), and if two candidates are to be selected (e.g., from the PMI candidate list based on costs) it is possible for the mode-types of the two selected candidates to be any combination of two from the supported mode types such as {intra+intra}, or {intra+intraTMP}, or {intra+IBC}, etc.

In some embodiments, the selection from the PMI candidates, which may be in the PMI candidate list, may depend on the candidates' template costs, in a manner similar to TIMD. Specifically, each candidate which may be in the list is used to generate a prediction for the template. The template cost for each candidate is measured according to the distortion between the template prediction of the candidate (i.e., the prediction for the template based on PMI of the candidate) and the template reconstruction (the reconstruction of the template.) The candidates, which may be in the list, may be reordered according to the costs. The video coder may also identify or record candidates with smallest costs as “promising” candidates.

In some embodiments, the first K candidates in the PMI candidates, which may be in the PMI candidate list, are selected. When K is 1, the only one selected candidate is used to generate the mode-type prediction for the current block. When K is larger than 1, multiple prediction hypotheses are generated, with each prediction hypothesis generated by one candidate selected, which may be from the list. In one embodiment, the multiple hypotheses are combined to form the mode-type prediction of the current block according to a pre-defined weighting. In some embodiments, the weights assigned by the predefined weighting are determined according to the corresponding costs for the multiple candidates selected. For example, a prediction hypothesis generated using a higher cost candidate would be assigned smaller weight than that using a lower cost candidate. In some embodiments, the final prediction is generated based on the mode-type prediction. In another embodiment, the final prediction of the current block is formed by combining the mode-type prediction with an inter prediction using blending weighting (e.g., based on template costs.)

In some embodiments, the weights being used for generating the combined prediction is similar to CIIP, e.g., the weight value of the mode-type prediction versus the inter prediction is determined based on the prediction modes and/or types of the top and left coded neighbors, as described in Section IV.a above.

In some embodiments, when the enabling flag for CIIP indicates that CIIP is applied to the current block, the combined prediction method described in this section is used to generate the final prediction of CIIP. In some embodiments, one additional flag is signaled to indicate whether the combined prediction method described in this section is to be used if the current block is already determined to be coded by a target mode. For example, if the target mode for the current block is CIIP and/or the existing enabling flag of CIIP indicates that CIIP is applied to the current block, then an additional flag is signaled to indicate whether the combined prediction method described in this section is to be used.

In some embodiments, the combined prediction uses inter prediction. Such inter prediction as part of the combined prediction may be merge mode prediction, AMVP prediction, or merge mode prediction combined with AMVP prediction.

The methods described in this disclosure can be enabled and/or disabled according to implicit rules (e.g., block width, height, or area) or according to explicit rules (e.g., syntax on block, tile, slice, picture, sps, or pps level). For example, the proposed method is applied when the block area is smaller or larger than a threshold. The term “block” in this invention can refer to TU/TB, CU/CB, PU/PB, pre-defined region, or CTU/CTB. Any combination of the proposed methods in this invention can be applied.

Any of the foregoing proposed methods can be implemented in encoders and/or decoders. For example, any of the proposed methods can be implemented in an inter/intra/IBC/prediction/transform module of an encoder, and/or an inter/intra/IBC/prediction/transform module of a decoder. Alternatively, any of the proposed methods can be implemented as a circuit coupled to the inter/intra/IBC/prediction/transform module of the encoder and/or the inter/intra/IBC/prediction/transform module of the decoder, so as to provide the information needed by the inter/intra/IBC/prediction/transform module.

### V. Example Video Encoder

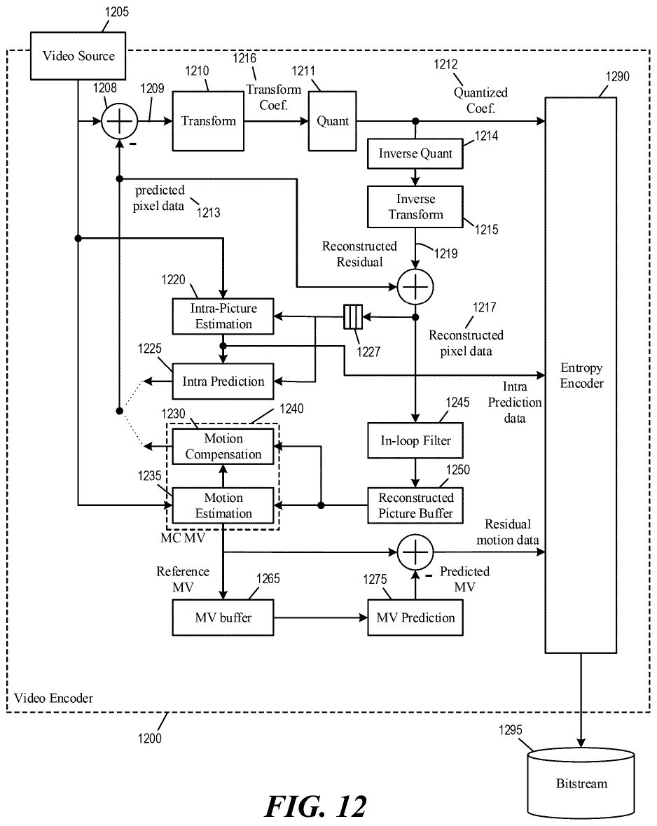

FIG. 12 illustrates an example video encoder 1200. As illustrated, the video encoder 1200 receives input video signal from a video source 1205 and encodes the signal into bitstream 1295. The video encoder 1200 has several components or modules for encoding the signal from the video source 1205, at least including some components selected from a transform module 1210, a quantization module 1211, an inverse quantization module 1214, an inverse transform module 1215, an intra-picture estimation module 1220, an intra-prediction module 1225, a motion compensation module 1230, a motion estimation module 1235, an in-loop filter 1245, a reconstructed picture buffer 1250, a MV buffer 1265, and a MV prediction module 1275, and an entropy encoder 1290. The motion compensation module 1230 and the motion estimation module 1235 are part of an inter-prediction module 1240.

In some embodiments, the modules 1210-1290 are modules of software instructions being executed by one or more processing units (e.g., a processor) of a computing device or electronic apparatus. In some embodiments, the modules 1210-1290 are modules of hardware circuits implemented by one or more integrated circuits (ICs) of an electronic apparatus. Though the modules 1210-1290 are illustrated as being separate modules, some of the modules can be combined into a single module.

The video source 1205 provides a raw video signal that presents pixel data of each video frame without compression. A subtractor 1208 computes the difference between the raw video pixel data of the video source 1205 and the predicted pixel data 1213 from the motion compensation module 1230 or intra-prediction module 1225 as prediction residual 1209. The transform module 1210 converts the difference (or the residual pixel data or residual signal 1208) into transform coefficients (e.g., by performing Discrete Cosine Transform, or DCT). The quantization module 1211 quantizes the transform coefficients into quantized data (or quantized coefficients) 1212, which is encoded into the bitstream 1295 by the entropy encoder 1290.

The inverse quantization module 1214 de-quantizes the quantized data (or quantized coefficients) 1212 to obtain transform coefficients, and the inverse transform module 1215 performs inverse transform on the transform coefficients to produce reconstructed residual 1219. The reconstructed residual 1219 is added with the predicted pixel data 1213 to produce reconstructed pixel data 1217. In some embodiments, the reconstructed pixel data 1217 is temporarily stored in a line buffer 1227 (or intra prediction buffer) for intra-picture prediction and spatial MV prediction. The reconstructed pixels are filtered by the in-loop filter 1245 and stored in the reconstructed picture buffer 1250. In some embodiments, the reconstructed picture buffer 1250 is a storage external to the video encoder 1200. In some embodiments, the reconstructed picture buffer 1250 is a storage internal to the video encoder 1200.

The intra-picture estimation module 1220 performs intra-prediction based on the reconstructed pixel data 1217 to produce intra prediction data. The intra-prediction data is provided to the entropy encoder 1290 to be encoded into bitstream 1295. The intra-prediction data is also used by the intra-prediction module 1225 to produce the predicted pixel data 1213.

The motion estimation module 1235 performs inter-prediction by producing MVs to reference pixel data of previously decoded frames stored in the reconstructed picture buffer 1250. These MVs are provided to the motion compensation module 1230 to produce predicted pixel data.

Instead of encoding the complete actual MVs in the bitstream, the video encoder 1200 uses MV prediction to generate predicted MVs, and the difference between the MVs used for motion compensation and the predicted MVs is encoded as residual motion data and stored in the bitstream 1295.

The MV prediction module 1275 generates the predicted MVs based on reference MVs that were generated for encoding previously video frames, i.e., the motion compensation MVs that were used to perform motion compensation. The MV prediction module 1275 retrieves reference MVs from previous video frames from the MV buffer 1265. The video encoder 1200 stores the MVs generated for the current video frame in the MV buffer 1265 as reference MVs for generating predicted MVs.

The MV prediction module 1275 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 1295 by the entropy encoder 1290.

The entropy encoder 1290 encodes various parameters and data into the bitstream 1295 by using entropy-coding techniques such as context-adaptive binary arithmetic coding (CABAC) or Huffman encoding. The entropy encoder 1290 encodes various header elements, flags, along with the quantized transform coefficients 1212, and the residual motion data as syntax elements into the bitstream 1295. The bitstream 1295 is in turn stored in a storage device or transmitted to a decoder over a communications medium such as a network.

The in-loop filter 1245 performs filtering or smoothing operations on the reconstructed pixel data 1217 to reduce the artifacts of coding, particularly at boundaries of pixel blocks. In some embodiments, the filtering or smoothing operations performed by the in-loop filter 1245 include deblock filter (DBF), sample adaptive offset (SAO), and/or adaptive loop filter (ALF). In some embodiments, luma mapping chroma scaling (LMCS) is performed before the loop filters.

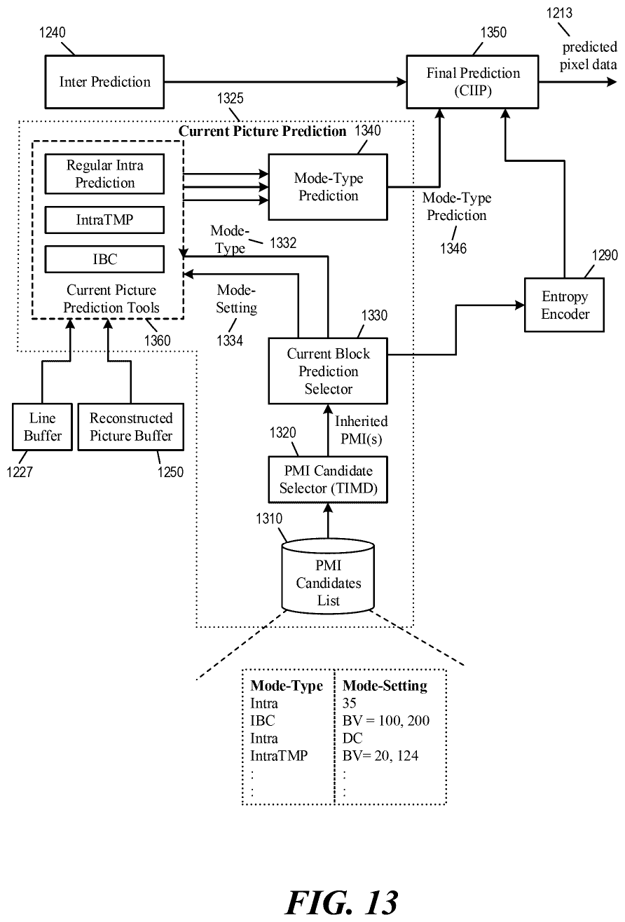

FIG. 13 illustrates portions of the video encoder 1200 that implement combined prediction. As illustrated, the samples of the predicted pixel data 1213 is provided by a final prediction module 1350, which may combine inter prediction (output of the inter prediction module 1240) with current picture prediction (output of a current picture prediction module 1325, which uses current picture reconstructed samples as reference samples for prediction) to become the predicted pixel data 1213. The final prediction module 1350 may perform CIIP combined prediction if enabled by the entropy encoder 1290, which also signals syntax elements into the bitstream 1295 indicating whether CIIP is to be used for the current block.

The current picture prediction may be generated using several different current picture prediction tools 1360 that correspond to different mode-types, which include regular intra prediction (such as DC, planar, or directional intra prediction), intraTMP, and/or IBC. Each current picture prediction tool uses samples stored in the line buffer 1227 and/or the reconstructed picture buffer 1250 to construct a respective predictor. Each current picture prediction tool generates its respective predictor based on mode-type indicator 1332 and/or mode-settings 1334 provided by the current block prediction selector 1330. Mode-settings for regular intra prediction may specify a particular directional mode or DC or planar. Mode-settings for intraTMP and IBC may specify one or more BVs.

The mode-type prediction module 1340 collects the predictors generated by the current picture prediction tools 1360 (directional intra prediction, intraTMP, IBC, etc.) to generate one or more mode-type predictor 1346. The mode-type prediction module 1340 may generate one or more mode-type predictor 1346 that may be combined prediction of the different predictors. The final prediction module 1350 may combine multiple predictors as multiple hypotheses in a manner similar to CIIP as described Section IV above, if enabled to do so by the entropy encoder 1290.

The current block predictor selector 1330 provides the mode-type indicator 1332 and/or the mode-settings 1334 to the current picture prediction tools 1360. The current block predictor selector 1330 may generate the mode-type indicator 1332 and/or the mode-settings 1334, and may provide information to the entropy encoder 1290, which prepares the bitstream 1295. The current block prediction selector 1330 may provide the mode-type indicator 1332 and/or the mode-settings 1334 based on one or more prediction mode information (PMI) that is inherited from previous coded blocks. The inherited PMIs may be provided by a PMI candidate selector 1320, which may select one or more PMI candidates from one or more PMI candidates, which may be in a PMI candidate list 1310, based on the candidates' template costs. The mode-types and/or mode-settings of blocks, which may serve as PMI candidates, are stored and/or to be used by subsequently coded blocks.

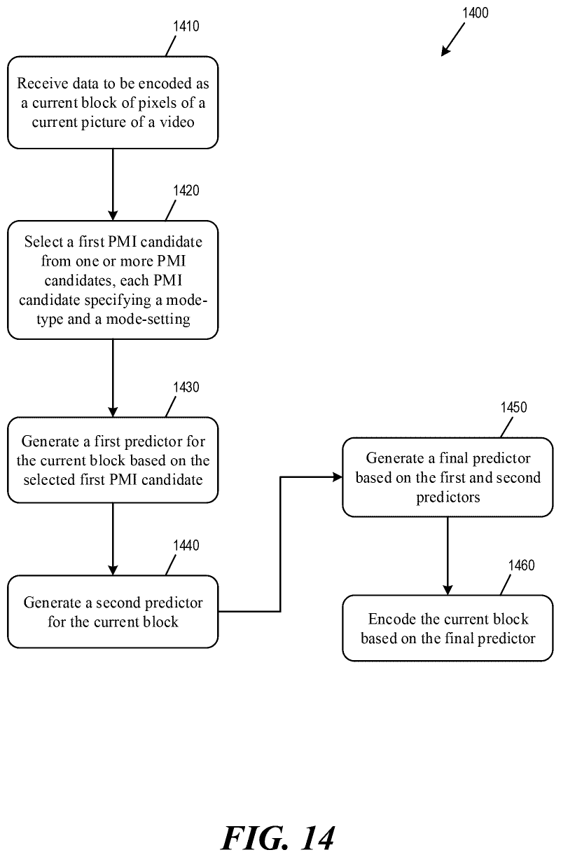

FIG. 14 conceptually illustrates a process 1400 for encoding a pixel block using combined prediction. In some embodiments, one or more processing units (e.g., a processor) of a computing device implementing the encoder 1200 performs the process 1400 by executing instructions stored in a computer readable medium. In some embodiments, an electronic apparatus implementing the encoder 1200 performs the process 1400.

The video encoder receives (at block 1410) receiving data to be encoded as a current block of pixels of a current picture of a video. The video encoder selects (at block 1420) at least one first prediction mode information (PMI) candidate from one or more PMI candidates.

The at least one first PMI candidate may be selected from the one or more PMI candidates based on template costs of the one or more PMI candidates. In some embodiments, the one or more PMI candidates comprise at least one of spatial adjacent, spatial non-adjacent, history, temporal, and default candidates. In some embodiments, the one or more PMI candidates are from a list of PMI candidates. In some embodiments, a merge candidate list is used to provide the one or more PMI candidates.

Each PMI candidate specifies a mode-type, a mode-setting, or both. For a first example, the mode-type of the selected PMI candidate may indicate that an intra prediction predictor is to be generated for current block, and the mode-setting of the selected PMI candidate may indicate information associated with an intra prediction mode such as angular direction or DC mode or planar mode for the intra prediction predictor. For a second example, the mode-type of the selected PMI candidate may indicate intra template matching prediction (intraTMP) mode, and the mode-setting of the selected PMI candidate may specify information associated with a block vector that is used for identifying a reference block in the current picture as a predictor for the current block. For a third example, the mode-type of the selected PMI candidate may indicate intra block copy (IBC) mode, and the mode-setting of the selected PMI candidate may specify information associated with a block vector that is used for identifying a reference block in the current picture as a predictor for the current block.

The encoder may select a second PMI candidate from the one or more PMI candidates. The first PMI candidate and the second PMI candidate may have different mode-types (e.g., {intra+intra}, or {intra+intraTMP}, or {intra+IBC}, etc.). In some embodiments, the first and second PMI candidates may be selected from the one or more PMI candidates based on template costs of the one or more PMI candidates.

The video encoder generates (at block 1430) at least one first predictor for current block based on the selected first PMI candidate. The video encoder generates (at block 1440) a second predictor for the current block. The second predictor may be generated by inter prediction.

The video encoder generates (at block 1450) a final predictor based on the at least one first predictor and the second predictor. In some embodiments, the at least one first predictor and second predictor are combined to generate the final predictor according to weighting value that is determined based on modes of coded neighbors above and left of the current block. An enabling flag may be signaled to indicate that a combined prediction mode is used (e.g., multiple predictors are combined) for the current block. In some embodiments, the first and second PMI candidates are used to generate first and second prediction hypotheses, which are blended to generate the final predictor. In some embodiments, the first and second prediction hypotheses are blended according to weights determined based on respective template costs of the first and second PMI candidates.

The video encoder encodes (at block 1460) the current block by using the final predictor to generate prediction residuals.

### VI. Example Video Decoder

In some embodiments, an encoder may signal (or generate) one or more syntax element in a bitstream, such that a decoder may parse said one or more syntax element from the bitstream.

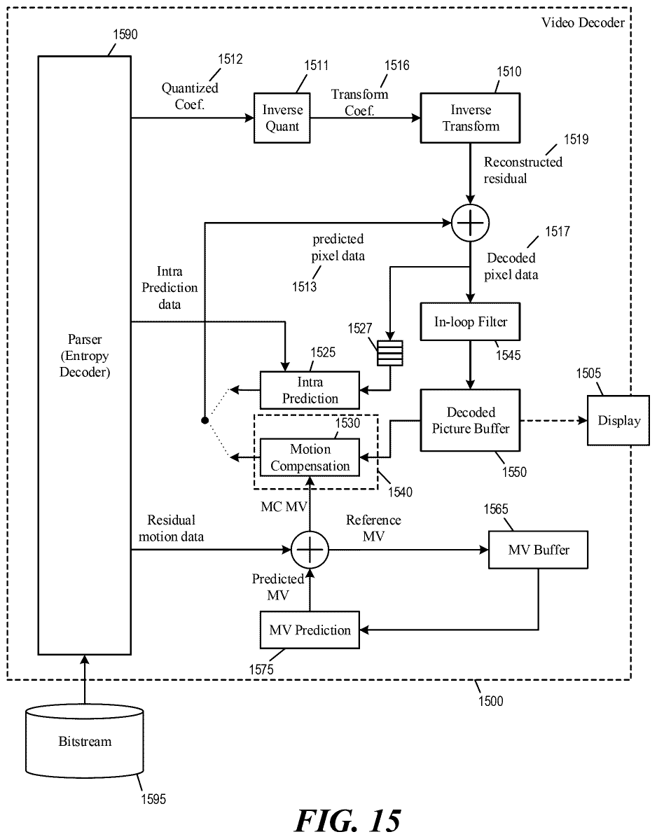

FIG. 15 illustrates an example video decoder 1500. As illustrated, the video decoder 1500 is an image-decoding or video-decoding circuit that receives a bitstream 1595 and decodes the content of the bitstream into pixel data of video frames for display. The video decoder 1500 has several components or modules for decoding the bitstream 1595, including some components selected from an inverse quantization module 1511, an inverse transform module 1510, an intra-prediction module 1525, a motion compensation module 1530, an in-loop filter 1545, a decoded picture buffer 1550, a MV buffer 1565, a MV prediction module 1575, and a parser 1590. The motion compensation module 1530 is part of an inter-prediction module 1540.

In some embodiments, the modules 1510-1590 are modules of software instructions being executed by one or more processing units (e.g., a processor) of a computing device. In some embodiments, the modules 1510-1590 are modules of hardware circuits implemented by one or more ICs of an electronic apparatus. Though the modules 1510-1590 are illustrated as being separate modules, some of the modules can be combined into a single module.

The parser 1590 (or entropy decoder) receives the bitstream 1595 and performs initial parsing according to the syntax defined by a video-coding or image-coding standard. The parsed syntax element includes various header elements, flags, as well as quantized data (or quantized coefficients) 1512. The parser 1590 parses out the various syntax elements by using entropy-coding techniques such as context-adaptive binary arithmetic coding (CABAC) or Huffman encoding.

The inverse quantization module 1511 de-quantizes the quantized data (or quantized coefficients) 1512 to obtain transform coefficients, and the inverse transform module 1510 performs inverse transform on the transform coefficients 1516 to produce reconstructed residual signal 1519. The reconstructed residual signal 1519 is added with predicted pixel data 1513 from the intra-prediction module 1525 or the motion compensation module 1530 to produce decoded pixel data 1517. The decoded pixels data are filtered by the in-loop filter 1545 and stored in the decoded picture buffer 1550. In some embodiments, the decoded picture buffer 1550 is a storage external to the video decoder 1500. In some embodiments, the decoded picture buffer 1550 is a storage internal to the video decoder 1500.

The intra-prediction module 1525 receives intra-prediction data from bitstream 1595 and according to which, produces the predicted pixel data 1513 from the decoded pixel data 1517 stored in the decoded picture buffer 1550. In some embodiments, the decoded pixel data 1517 is also stored in a line buffer 1527 (or intra prediction buffer) for intra-picture prediction and spatial MV prediction.

In some embodiments, the content of the decoded picture buffer 1550 is used for display. A display device 1505 either retrieves the content of the decoded picture buffer 1550 for display directly, or retrieves the content of the decoded picture buffer to a display buffer. In some embodiments, the display device receives pixel values from the decoded picture buffer 1550 through a pixel transport.

The motion compensation module 1530 produces predicted pixel data 1513 from the decoded pixel data 1517 stored in the decoded picture buffer 1550 according to motion compensation MVs (MC MVs). These motion compensation MVs are decoded by adding the residual motion data received from the bitstream 1595 with predicted MVs received from the MV prediction module 1575.

The MV prediction module 1575 generates the predicted MVs based on reference MVs that were generated for decoding previous video frames, e.g., the motion compensation MVs that were used to perform motion compensation. The MV prediction module 1575 retrieves the reference MVs of previous video frames from the MV buffer 1565. The video decoder 1500 stores the motion compensation MVs generated for decoding the current video frame in the MV buffer 1565 as reference MVs for producing predicted MVs.

The in-loop filter 1545 performs filtering or smoothing operations on the decoded pixel data 1517 to reduce the artifacts of coding, particularly at boundaries of pixel blocks. In some embodiments, the filtering or smoothing operations performed by the in-loop filter 1545 include deblock filter (DBF), sample adaptive offset (SAO), and/or adaptive loop filter (ALF). In some embodiments, luma mapping chroma scaling (LMCS) is performed before the loop filters.

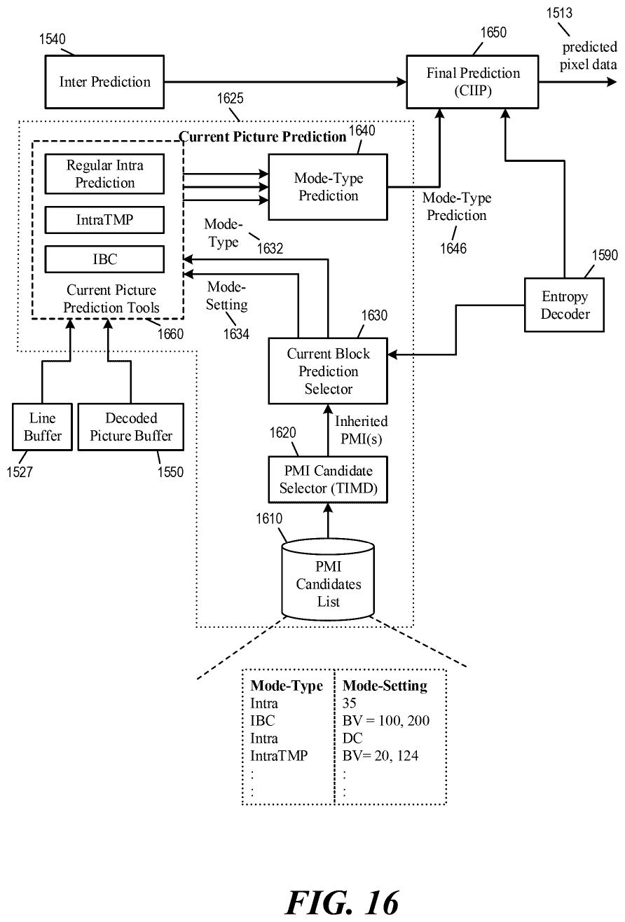

FIG. 16 illustrates portions of the video decoder 1500 that implement combined prediction. As illustrated, the samples of the predicted pixel data 1513 is provided by a final prediction module 1650, which may combine inter prediction (output of the inter prediction module 1540) with current picture prediction (output of a current picture prediction module 1625, which uses current picture reconstructed samples as reference samples for prediction) to become the predicted pixel data 1513. The final prediction module 1650 may perform CIIP combined prediction if enabled by the entropy decoder 1590, which receives syntax elements from the bitstream 1595 that indicates whether CIIP is to be used for the current block.

The current picture prediction may be generated using several different current picture prediction tools 1660 that correspond to different mode-types, which include regular intra prediction (such as DC, planar, or directional intra prediction), intraTMP, and/or IBC. Each current picture prediction tool uses samples stored in the line buffer 1527 and/or the decoded picture buffer 1550 to construct a respective predictor. Each current picture prediction tool generates its respective predictor based on mode-type indicator 1632 and/or mode-settings 1634 provided by the current block prediction selector 1630. Mode-settings for regular intra prediction may specify a particular directional mode or DC or planar. Mode-settings for intraTMP and IBC may specify one or more BVs.

The mode-type prediction module 1640 collects the predictors generated by the current picture prediction tools 1660 (directional intra prediction, intraTMP, IBC, etc.) to generate one or more mode-type predictor 1646. The mode-type prediction module 1640 may generate one or more mode-type predictor 1646 that may be combined prediction of the different predictors. The final prediction module 1650 may combine multiple predictors as multiple hypotheses in a manner similar to CIIP as described Section IV above, if enabled to do so by the entropy decoder 1590.

The current block predictor selector 1630 provides the mode-type indicator 1632 and/or the mode-settings 1634 to the current picture prediction tools 1660. The current block predictor selector 1630 may generate the mode-type indicator 1632 and/or the mode-settings 1634 based on input from the entropy decoder 1590, which parses the bitstream 1595 for the information. The current block prediction selector 1630 may provide the mode-type indicator 1632 and/or the mode-settings 1634 based on one or more prediction mode information (PMI) that is inherited from previous coded blocks. The inherited PMIs may be provided by a PMI candidate selector 1620, which may select one or more PMI candidates from one or more PMI candidates, which may be in a PMI candidate list 1610, based on the candidates' template costs. The mode-types and/or mode-settings of blocks, which may serve as PMI candidates, are stored and/or to be used by subsequently coded blocks.

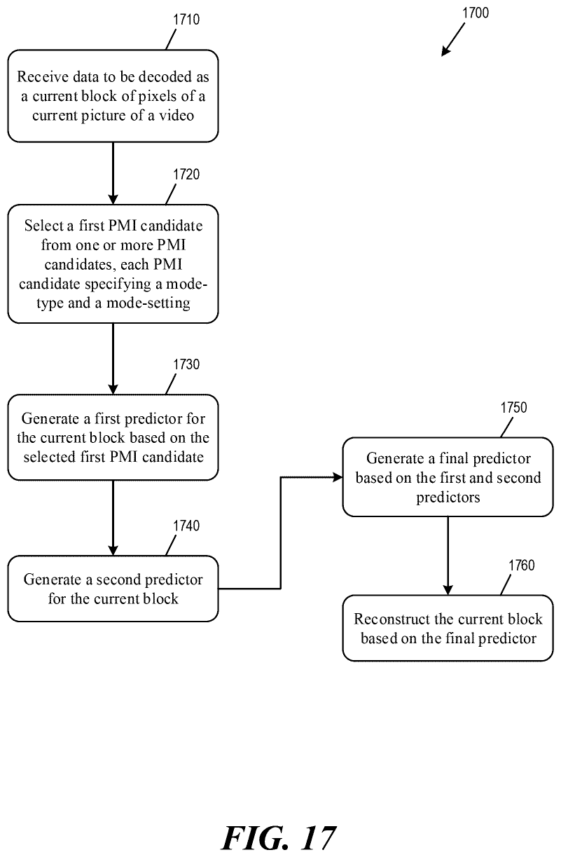

FIG. 17 conceptually illustrates a process 1700 for decoding a pixel block using combined prediction. In some embodiments, one or more processing units (e.g., a processor) of a computing device implementing the decoder 1500 performs the process 1700 by executing instructions stored in a computer readable medium. In some embodiments, an electronic apparatus implementing the decoder 1500 performs the process 1700.

The video decoder receives (at block 1710) receiving data to be decoded as a current block of pixels of a current picture of a video. The video decoder selects (at block 1720) at least one first prediction mode information (PMI) candidate from one or more PMI candidates. The at least one first PMI candidate may be selected from the one or more PMI candidates based on template costs of the one or more PMI candidates. In some embodiments, the one or more PMI candidates comprise at least one of spatial adjacent, spatial non-adjacent, history, temporal, and default candidates. In some embodiments, the one or more PMI candidates are from a list of PMI candidates. In some embodiments, a merge candidate list is used to provide the one or more PMI candidates.

Each PMI candidate specifies a mode-type, a mode-setting, or both. For a first example, the mode-type of the selected PMI candidate may indicate that an intra prediction predictor is to be generated for current block, and the mode-setting of the selected PMI candidate may indicate information associated with an intra prediction mode such as angular direction or DC mode or planar mode for the intra prediction predictor. For a second example, the mode-type of the selected PMI candidate may indicate intra template matching prediction (intraTMP) mode, and the mode-setting of the selected PMI candidate may specify information associated with a block vector that is used for identifying a reference block in the current picture as a predictor for the current block. For a third example, the mode-type of the selected PMI candidate may indicate intra block copy (IBC) mode, and the mode-setting of the selected PMI candidate may specify information associated with a block vector that is used for identifying a reference block in the current picture as a predictor for the current block.

The decoder may select a second PMI candidate from the one or more PMI candidates. The first PMI candidate and the second PMI candidate may have different mode-types (e.g., {intra+intra}, or {intra+intraTMP}, or {intra+IBC}, etc.). In some embodiments, the first and second PMI candidates may be selected from the one or more PMI candidates based on template costs of the one or more PMI candidates.

The video decoder generates (at block 1730) at least one first predictor for current block based on the selected at least first PMI candidate. The video decoder generates (at block 1740) a second predictor for the current block. The second predictor may be generated by inter prediction.

The video decoder generates (at block 1750) a final predictor based on the at least one first predictor and the second predictor. In some embodiments, the at least one first predictor and second predictor are combined to generate the final predictor according to weighting value that is determined based on modes of coded neighbors above and left of the current block. An enabling flag may be signaled to indicate that a combined prediction mode is used (e.g., multiple predictors are combined) for the current block. In some embodiments, the first and second PMI candidates are used to generate first and second prediction hypotheses, which are blended to generate the final predictor. In some embodiments, the first and second prediction hypotheses are blended according to weights determined based on respective template costs of the first and second PMI candidates.

The video decoder reconstructs (at block 1760) the current block by using the final predictor and corresponding prediction residuals. The decoder may then provide the reconstructed current block for display as part of the reconstructed current picture.

### VII. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

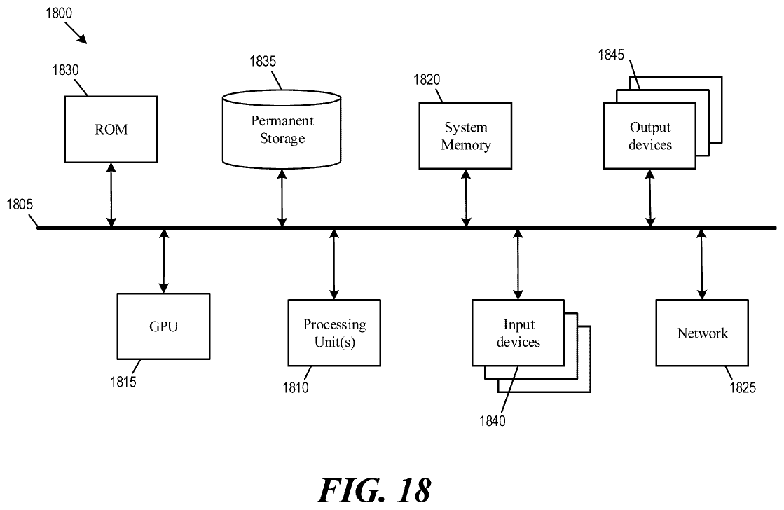

FIG. 18 conceptually illustrates an electronic system 1800 with which some embodiments of the present disclosure are implemented. The electronic system 1800 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1800 includes a bus 1805, processing unit(s) 1810, a graphics-processing unit (GPU) 1815, a system memory 1820, a network 1825, a read-only memory 1830, a permanent storage device 1835, input devices 1840, and output devices 1845.

The bus 1805 collectively represents all system, peripheral, and chipset buses that communicatively connect the numerous internal devices of the electronic system 1800. For instance, the bus 1805 communicatively connects the processing unit(s) 1810 with the GPU 1815, the read-only memory 1830, the system memory 1820, and the permanent storage device 1835.

From these various memory units, the processing unit(s) 1810 retrieves instructions to execute and data to process in order to execute the processes of the present disclosure. The processing unit(s) may be a single processor or a multi-core processor in different embodiments. Some instructions are passed to and executed by the GPU 1815. The GPU 1815 can offload various computations or complement the image processing provided by the processing unit(s) 1810.

The read-only-memory (ROM) 1830 stores static data and instructions that are used by the processing unit(s) 1810 and other modules of the electronic system. The permanent storage device 1835, on the other hand, is a read-and-write memory device. This device is a non-volatile memory unit that stores instructions and data even when the electronic system 1800 is off. Some embodiments of the present disclosure use a mass-storage device (such as a magnetic or optical disk and its corresponding disk drive) as the permanent storage device 1835.

Other embodiments use a removable storage device (such as a floppy disk, flash memory device, etc., and its corresponding disk drive) as the permanent storage device. Like the permanent storage device 1835, the system memory 1820 is a read-and-write memory device. However, unlike storage device 1835, the system memory 1820 is a volatile read-and-write memory, such a random access memory. The system memory 1820 stores some of the instructions and data that the processor uses at runtime. In some embodiments, processes in accordance with the present disclosure are stored in the system memory 1820, the permanent storage device 1835, and/or the read-only memory 1830. For example, the various memory units include instructions for processing multimedia clips in accordance with some embodiments. From these various memory units, the processing unit(s) 1810 retrieves instructions to execute and data to process in order to execute the processes of some embodiments.

The bus 1805 also connects to the input and output devices 1840 and 1845. The input devices 1840 enable the user to communicate information and select commands to the electronic system. The input devices 1840 include alphanumeric keyboards and pointing devices (also called “cursor control devices”), cameras (e.g., webcams), microphones or similar devices for receiving voice commands, etc. The output devices 1845 display images generated by the electronic system or otherwise output data. The output devices 1845 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 18, bus 1805 also couples electronic system 1800 to a network 1825 through a network adapter (not shown). In this manner, the computer can be a part of a network of computers (such as a local area network (“LAN”), a wide area network (“WAN”), or an Intranet, or a network of networks, such as the Internet. Any or all components of electronic system 1800 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 14 and FIG. 17) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving data to be encoded or decoded as a current block of pixels of a current picture of a video;
selecting at least one first prediction mode information (PMI) candidate from one or more PMI candidates, each PMI candidate specifying a mode-type, a mode-setting, or both;
generating at least one first predictor for the current block based on the selected at least one first PMI candidate;
generating a second predictor for the current block;
generating a final predictor based on the at least one first predictor and the second predictor; and
encoding or decoding the current block based on the final predictor.

2. The video coding method of claim 1, wherein each PMI candidate comprises information associated with an intra prediction mode or a block vector.

3. The video coding method of claim 1, wherein the mode-type of the selected PMI candidate indicates that an intra prediction predictor is to be generated for current block, and the mode-setting of the selected PMI candidate indicates information associated with an intra prediction mode comprising angular direction or DC mode or planar mode for the intra prediction predictor.

4. The video coding method of claim 1, wherein the mode-type of the selected PMI candidate indicates intra template matching prediction (intraTMP) mode, wherein the mode-setting of the selected PMI candidate specifies information associated with a block vector that is used for identifying a reference block in the current picture as a predictor for the current block.

5. The video coding method of claim 1, wherein the mode-type of the selected PMI candidate indicates intra block copy (IBC) mode, wherein the mode-setting of the selected PMI candidate specifies information associated with a block vector that is used for identifying a reference block in the current picture as a predictor for the current block.

6. The video coding method of claim 1, wherein the at least one first PMI candidate is selected from one or more PMI candidates based on template costs of the one or more PMI candidates.

7. The video coding method of claim 1, wherein the at least one first PMI candidates are from a list comprising the one or more PMI candidates.

8. The video coding method of claim 1, further comprising selecting a second PMI candidate from the one or more PMI candidates.

9. The video coding method of claim 8, wherein the first PMI candidate and the second PMI candidate have different mode-types.

10. The video coding method of claim 8, wherein the first and second PMI candidates are selected from the one or more PMI candidates based on template costs of the one or more PMI candidates.

11. The video coding method of claim 8, wherein first and second prediction hypotheses generated according to the first and second PMI candidates are blended.

12. The video coding method of claim 11, wherein the first and second prediction hypotheses are blended according to weights determined based on respective template costs of the first and second PMI candidates.

13. The video coding method of claim 1, wherein the one or more PMI candidates comprises at least one of spatial adjacent, spatial non-adjacent, history, temporal, and default candidates.

14. The video coding method of claim 1, wherein the one or more PMI candidates are derived from a merge candidate list.

15. The video coding method of claim 1, wherein the second predictor is generated by inter prediction.

16. The video coding method of claim 1, wherein the at least one first predictor and second predictor are combined to generate the final predictor according to weighting value that is determined based on modes of coded neighbors above and left of the current block.

17. The video coding method of claim 16, wherein an enabling flag is signaled to indicate that multiple predictors are combined for the current block.

18. An electronic apparatus comprising:
a video coder circuit configured to perform operations comprising:
receiving data to be encoded or decoded as a current block of pixels of a current picture of a video;
selecting at least one first prediction mode information (PMI) candidate from one or more PMI candidates, each PMI candidate specifying a mode-type, a mode-setting, or both;
generating at least one first predictor for the current block based on the selected at least one first PMI candidate;
generating a second predictor for the current block;
generating a final predictor based on the at least one first predictor and the second predictor; and
encoding or decoding the current block based on the final predictor.

19. A video decoding method comprising:
receiving data to be decoded as a current block of pixels of a current picture of a video;
selecting at least one first prediction mode information (PMI) candidate from one or more PMI candidates, each PMI candidate specifying a mode-type, a mode-setting, or both;
generating at least one first predictor for the current block based on the selected at least one first PMI candidate;
generating a second predictor for the current block;
generating a final predictor based on the at least one first predictor and the second predictor; and
reconstructing the current block based on the final predictor.
